(19) United States
(12) Patent Application Publication
(10) Pub. No.: US 2007/0158277 A1
(43) Pub. Date: Jul. 12, 2007

(54) Needle-punched non-woven filtration media and in-tank fuel filters suitable for filtering alternative fuels

(76) Inventors: Clyde Bachand, Lake Geneva, WI (US); Yu Li, Lake Geneva, WI (US)

Correspondence Address: Anthony G. Fussner, Suite 400, 7700 Bonhomme, St. Louis, MO, 63105, US

(21) Appl. No.: 11/599,689

(22) Filed: Nov. 15, 2006

Related U.S. Application Data
(60) Provisional application No. 60/757,512, filed on Jan. 9, 2006.

(51) Int. Cl. B01D 39/00

(52) U.S. Cl. 210/767; 210/505

(57) ABSTRACT

Aspects of the present disclosure provide various embodiments of filtration media and in-tank fuel filters suitable for filtration of alternative fuels. In one exemplary embodiment, an in-tank fuel filter generally includes a filter body. The filter body includes an interior and first and second panels of filtration media. The first and second panels of filtration media include needle-punched non-woven filtration media. There is an opening in the filter body for providing fluid communication with the interior of the filter body.

### CROSS-REFERENCE TO RELATED APPLICATION

This application claims the benefit of U.S. Provisional Patent Application No. 60/757,512 filed Jan. 9, 2006, the disclosure of which is incorporated herein by reference.

### FIELD

The present disclosure relates generally to needle-punched non-woven filtration media and in-tank fuel filters suitable for filtering alternative fuels, such as flex fuels, methanol, ethanol, alcohol, etc.

### BACKGROUND

The statements in this background section merely provide background information related to the present disclosure and may not constitute prior art.

Fuel filters are used in vehicular fuel systems to filter undesirable contaminants from the fuel required for the operation of the vehicle's engine. In many fuel filters, fabric is used to preclude flow of unfiltered fuel into the engine, thereby helping to prevent unwanted (and possibly damaging particles) from flowing into the engine. These fuel filters with fabric generally perform well with conventional gasoline engines.

But more recently, automobiles are being developed for operation with alternative fuels, such as methanol, ethanol, alcohol, flex fuels, among other possible alternative fuels derived from resources other than petroleum, etc. Alternative fuels oftentimes are not compatible with the fabric materials used in conventional fuel filters. For example, alternative fuels may be considerably dirty with numerous particulates and/or fairly large particulates as compared to gasoline. Such dirty alternative fuels would therefore require significant filtration, which can cause the filtration fabrics to swell and starve the engine of fuel if the filters are not frequently replaced. But frequent replacement of fuel filters can be cumbersome and lead to increased costs associated with operating automobiles on alternative fuels.

### SUMMARY

According to various aspects of the present disclosure, there are provided various exemplary embodiments of filtration media and in-tank fuel including needle-punched non-woven materials. In one particular exemplary embodiment, an in-tank fuel filter generally includes a filter body. The filter body includes an interior and first and second panels of filtration media. The first and second panels of filtration media include needle-punched non-woven filtration media. There is an opening in the filter body for providing fluid communication with the interior of the filter body.

In another exemplary embodiment, there is provided filtration media for in-tank fuel filter assemblies for filtration of alternative fuels. The filtration media generally includes at least one needle-punched non-woven material.

Other aspects of the present disclosure relate to methods for filtering fluids. In one particular exemplary embodiment, a method generally includes positioning a filter relative to a fluid flow such that the filter's needle-punched non-woven filtration media is in fluid communication with the fluid flow for receiving the fluid and then filtering particulates from the fluid.

Further aspects and features of the present disclosure will become apparent from the detailed description provided hereinafter. In addition, any one or more aspects of the present disclosure may be implemented individually or in any combination with any one or more of the other aspects of the present disclosure. It should be understood that the detailed description and specific examples, while indicating exemplary embodiments of the present disclosure, are intended for purposes of illustration only and are not intended to limit the scope of the present disclosure.

### DRAWINGS

The drawings described herein are for illustration purposes only and are not intended to limit the scope of the present disclosure in any way.

FIG. 1 is a diagrammatic elevation view (with portions broken away for clarity) of a fuel tank including an in-tank fuel filter according to exemplary embodiments of the present disclosure;

FIG. 2 is a perspective view of the exemplary in-tank fuel filter shown in FIG. 1 with a portion broken away for clarity;

FIG. 3 is a partial cross-sectional view of the upper and lower panels of the in-tank fuel filter shown in FIG. 2 taken along the line 3-3 in FIG. 2 and showing each panel having an outer protective layer, a inner layer of spun-bonded material, and a layer of needle-punched non-woven filtration media disposed between the outer protective layer and the spun-bonded layer according to exemplary embodiments of the present disclosure;

FIG. 4 is a partial cross-sectional view of an exemplary in-tank fuel filter panel having an outer protective layer, a pair of layers of spun-bonded material, and a layer of needle-punched non-woven filtration media disposed between the spun-bonded layers according to other exemplary embodiments of the present disclosure;

FIG. 5 is a partial cross-sectional view of an exemplary in-tank fuel filter panel having needle-punched non-woven filtration media and an outer protective layer according to further exemplary embodiments of the present disclosure; and

FIG. 6 is a partial cross-sectional view of an exemplary in-tank fuel filter panel having an outer protective layer, a layer of needle-punched non-woven filtration media, and a layer of spun-bonded material disposed between the outer protective layer and the layer of needle-punched non-woven filtration media according to still further exemplary embodiments of the present disclosure.

### DETAILED DESCRIPTION

The following description is merely exemplary in nature and is in no way intended to limit the present disclosure, application, or uses. It should be understood that throughout the drawings, corresponding reference numerals indicate like or corresponding parts and features.

According to various aspects of the present disclosure, there are provided various exemplary embodiments of filtration media and in-tank fuel including needle-punched non-woven materials. In one particular exemplary embodiment, an in-tank fuel filter generally includes a filter body. The filter body includes an interior and first and second panels of filtration media. The first and second panels of filtration media include needle-punched non-woven filtration media. There is an opening in the filter body for providing fluid communication with the interior of the filter body.

In another exemplary embodiment, there is provided filtration media for in-tank fuel filter assemblies suitable for use (e.g., chemically compatible, etc.) in filtration of alternative fuels, such as methanol, ethanol, alcohol, flex fuels, among other possible alternative fuels derives from resources other than petroleum, etc. The filtration media generally includes at least one needle-punched non-woven material. Other aspects of the present disclosure relate to methods for filtering fluids. In one particular exemplary embodiment, a method generally includes positioning a filter relative to a fluid flow such that the filter's needle-punched non-woven filtration media is in fluid communication with the fluid flow for receiving the fluid and then filtering particulates from the fluid.

Further aspects of the present disclosure relate to methods of making needle-punched non-woven filtration media and filters including the same. Any one or more aspects of the present disclosure may be implemented individually or in any combination with any one or more of the other aspects of the present disclosure.

Referring now to FIG. 1, there is shown an exemplary vehicle fuel tank 100. Also shown in FIG. 1 is an exemplary in-tank fuel filter 150 positioned within the fuel tank 100 for filtering fuel with the vehicle fuel tank 100. While aspects of the present disclosure are not limited to use with fuel tanks of any particular type or kind, a brief description will nevertheless be provided of the exemplary vehicle fuel tank 100.

The fuel tank 100 may be made from a wide variety of materials, such as metal, plastic, other suitable fuel resistant material, etc. The vehicle fuel tank 100 includes an inlet or filler tube 104 for receiving fuel into the fuel tank from a source external to the vehicle (e.g., a pump at a roadside gas station, etc.).

With continued reference to FIG. 1, an electric fuel pump module 108 is mounted within an opening 112 of the fuel tank 100. The electric fuel pump 108, may, for example, be secured to the fuel tank 100 by threaded bolts 116 and/or by other suitable attachment means. As shown, the electric fuel pump module 108 includes an electric pump 120 for pumping fuel under pressure to a fuel outlet or supply line 124, which, in turn, is in fluid communication with a the vehicle's engine (not shown). The fuel pump 120 may receive electrical energy from an electrical cable 128 (or via other suitable means, etc.).

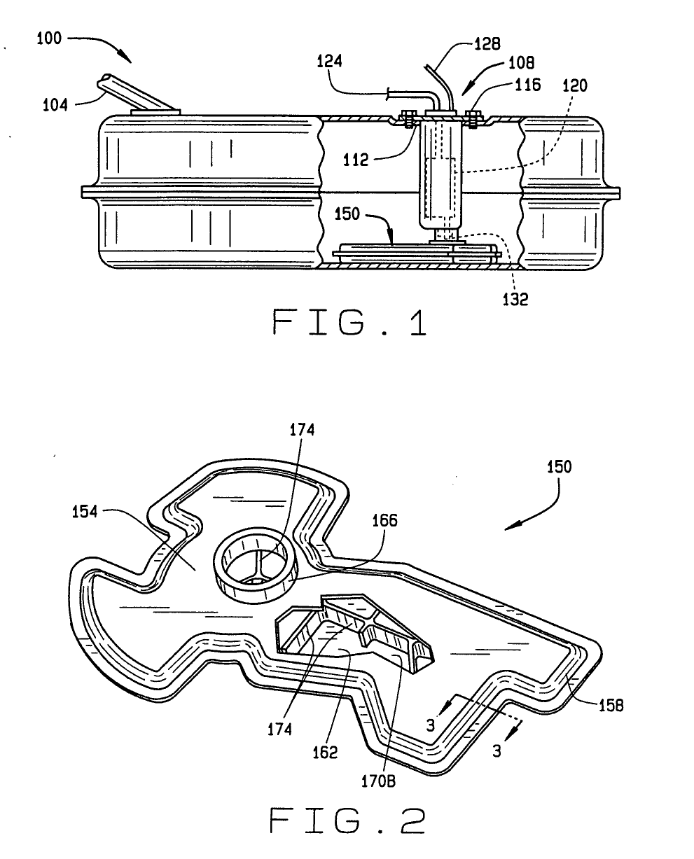

The electric fuel pump module 108 also includes an inlet fitting 132. The inlet fitting 132 defines an inlet opening in fluid communication with the suction side of the fuel pump 120. The inlet fitting 132 receives and retains an in-tank fuel filter 150 (also shown in FIG. 2) embodying one or more aspects of the present disclosure.

Before continuing with the description of the in-tank fuel filter 150, it should be noted that the fuel tank 100 shown in FIG. 1 is only one example of a fuel tank with which can be used one or more filtration media and/or in-tank fuel filters of the present disclosure. In other embodiments, filtration media and/or in-tank fuel filters of the present disclosure may be used with other fuel tank configurations besides the vehicle fuel tank shown in FIG. 1, including other vehicle fuel tank configurations and/or non-automotive or stationary fuel tanks. In addition, aspects of the present disclosure should not be limited to applications for filtering fuel only in that aspects of the present disclosure may also be used with a wide range of other applications for filtering other fluids besides fuel.

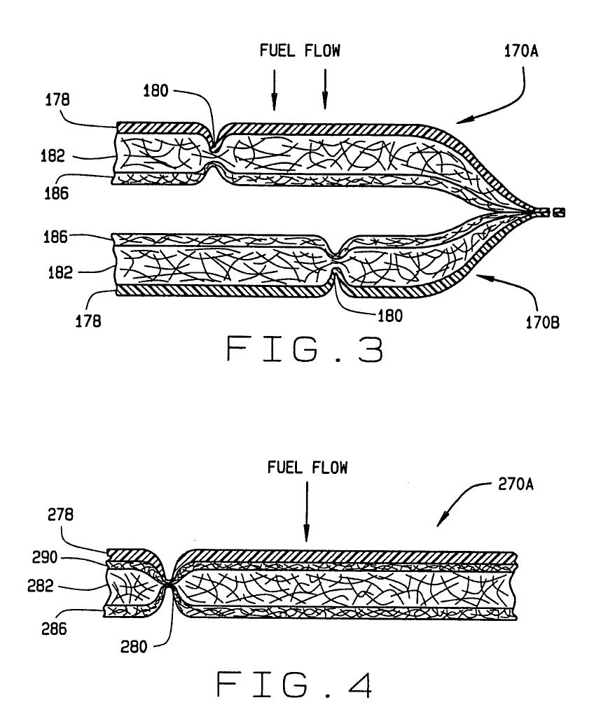

With reference to FIG. 2, the exemplary in-tank fuel filter 150 includes a filter body 154. The filter body 154 includes a seam or seal 158 such that the filter body 154 forms an interior space 162 that is closed (except for an outlet fitting 166). The interior space 162 is defined generally between a first or upper panel 170A and a second or lower panel 170B (panels 170A and 170B are also shown in FIG. 3). In this particular embodiment, the seam or seal 158 thus seals the pair of panels 170A and 170B (which are shown of equal size and corresponding irregular shape) together around their aligned, adjacent peripheries.

Alternative embodiments of an in-tank fuel filter may include a filter body that includes two more regularly-shaped panels (e.g., round, rectangular, oval, triangular, polygonal, hexagonal, pentagonal, etc.) sealed together along their aligned, adjacent peripheries. Accordingly, aspects of the present disclosure are not limited to any particular configuration (e.g., shape, size, etc.) of filter body.

In further embodiments, an in-tank fuel filter may include a filter body formed from a single swatch of composite filtration media that is folded over along at least one edge, and then closed by one or more seals along the remaining or non-folded edges. For example, one particular embodiment may include a single generally rectangular swatch of filtration media folded along one of the four edges with the other three remaining or non-folded edges being closed by a seam or seal. Accordingly, aspects of the present disclosure are not limited to filter bodies formed by any one particular method or operation.

With continued reference to FIG. 2, the in-tank fuel filter 150 includes the outlet fitting 166. The outlet fitting 166 is shown disposed along the upper panel 170A and is generally circular. Alternative configurations (e.g., shapes, sizes, locations, etc.) are also possible for the outlet fitting 166 depending, for example, on the particular fuel tank in which the fuel filter will be used.

The outlet fitting 166 may be removably, permanently, or semi-permanently secured to the upper panel 170A using a wide range of attachment means (e.g., spring metal mounting and retaining washer, adhesives, mechanical fasteners, combinations thereof, etc.). In addition, the outlet fitting 166 may also include a wide range of means for removably, permanently, or semi-permanently securing the outlet fitting 166 to the inlet fitting 132 of the fuel pump 120 (FIG. 1). For example, in those exemplary embodiments in which the outlet fitting 166 is attached to the upper panel 170A by using a spring metal mounting and retaining washer, the washer may include a plurality of circumferentially arranged radial inwardly extending spring tabs. In alternative embodiments, a wide variety of other suitable devices and means may be employed for engaging the outlet fitting 166 to the fuel pump's inlet fitting 132, such as interlocking members, spring clips, mounting ears, latches, retaining tabs, combinations thereof, etc., on the outlet fitting 166 that cooperate with complementarily configured features of the fuel pump's inlet fitting 132 to thereby attach the fuel filter 150 thereto.

A wide range of materials may be used for the outlet fitting 166, including fuel tolerant materials like nylon, polyester, acetal, etc. In some embodiments, the outlet fitting 166 may be molded in-situ on the upper or lower panel 170A or 170B of the fuel filter 150. In yet other embodiments, the outlet fitting 166 may be assembled from two or more component parts.

With continued reference to FIG. 2, the fuel filter 150 may also include one or more ribs, runners, or separators 174. In various embodiments, these separators 174 may be molded in-situ to either or both of the upper and lower panels 170A and 170B. These separators 174 may be sized with sufficient height above the panel's interior surface on which they are formed for helping maintain separation of the panels' interior surfaces apart from one another. This helps maintain the interior space 162 within the filter body 154, which, in turn, facilitates fuel flow within the interior space 162 into the outlet fitting 166. Alternatively, the separators 174 may be formed in other ways besides in-situ molding, and/or the separators 174 may be formed either with or independently of the outlet fitting 166.

Referring now to FIG. 3, there is shown a partial cross-sectional view of the upper and lower panels 170A and 170B of the in-tank fuel filter 150. As shown in FIG. 3, each panel 170A and 170B includes three layers 178, 182, and 186. In addition, each panel 170A, 170B is bonded (at compressed regions 180) such that each panel 170A, 170B has spaced-apart regions of laminated or coupled layers 178, 182, and 186. A wide range of methods may be used for bonding the panels 170A and 170B and forming the spaced-apart regions of laminated or coupled layers 178, 182, and 186. By way of example only, various embodiments include the panels 170A, 170B being sonically point-bonded or ultrasonically welded as evidence by compressed regions 180. In such embodiments, the portions of the layers 178, 182, 186 disposed between two of such compressed regions 180 need not be directly and mechanically bonded to one another, for example, with adhesives, ultrasonically welded, etc. In yet other embodiments, however, further bonding may be employed between two or more of the layers 178, 182, 186 in addition to the bonding at compressed regions 180.

In the illustrated embodiment of FIG. 3, each panel 170A and 170B includes at least one outer protective layer 178, at least one inner layer of spun-bonded material 186, and at least one layer of needle-punched non-woven filtration media 182 disposed generally between the outer and inner layers 178 and 186. Alternatively, each panel 170A and 170B may include more or less than these three layers 178, 182, 186, and each panel 170A and 170B need not include the same type and number of layers as the other panel. Moreover, any one or more of these layers 178, 182, and 186 may be formed from more than a single layer of material. For example, any of the layers 178, 182, 186 may comprise two or more layers laminated or otherwise bonded to one another.

The outer layer 178 may be formed from a relatively coarse and fuel tolerant material, such as nylon, polyester, acetal, Teflon, combinations thereof, etc. By way of example only, various embodiments include an outer protective layer 178 that is a woven screen of polyester or acetal. In other embodiments, the outer protective layer 178 may comprise a relatively coarse extruded mesh formed from any of a wide range of suitable fuel tolerant materials, such as acetal, polyester, nylon, Teflon, combinations thereof, etc.

In general, the relative coarseness or comparative pore sizes between the outer layer 178 and the other layers 182, 186 means that the outer layer contributes relatively little from the standpoint of filtration (except perhaps for straining out fairly large particulates). Rather, various embodiments include one or more outer protective layers 178 for providing a suitably durable protective coating for the more fragile and less durable inner layers 182, 186 (which in this particular embodiment comprise respective needle-punched and spun-bonded non-woven materials).

The protection afforded by the outer layers 178 may also help protect the inner layers 182, 186 from abrasion. Abrasion is a common occurrence for in-tank fuel filter applications. This is because in-tank fuel filters are commonly disposed at an end of a suction tube or directly at the inlet of an in-tank fuel pump. For achieving sufficient fuel suction from the tank, the filter may be positioned against the bottom surface of the fuel tank such that the lower fuel filter surface may and often is subjected to abrasive action due to relative movement and contact between the filter's lower surface and the fuel tank's bottom surface. The outer layers 178 may also be configured to provide support and reinforce the inner layers 182, 186 during filtration.

In addition to the outer protective layers 178 just described, each panels 170A and 170B further includes at least one layer 182 of needle-punched non-woven filtration media. In this particular embodiment of FIG. 3, this needle-punched layer 182 provides the primary or principal filtration for the filter.

The needle-punched layer 182 may be relatively fine and be tailored or configured for filtration focused in the seventy to one hundred micron range (or thereabout). Alternative embodiments, however, may include coarser and/or finer needle-punched non-woven materials configured for filtering larger or smaller particulates.

A wide range of materials may be used for the needle-punched non-woven filtration media of layer 182. Exemplary materials include needle-punched non-woven felt, polyester and/or acetal materials formed from one or more of polyester fibers, polyester staple fibers, acetal fibers, acetal staple fibers, polyacetal fibers, polyacetal staple fibers, acetal copolymer fibers, acetal copolymer staple fibers, polyacetal polymers, polyacetal polymer fibers, polyacetal polymer staple fibers, Delrin® acetal, Celcon® acetal, combinations thereof, among other suitable materials. By way of general background, Delrin® acetal (e.g., a material made by DuPont® Corporation) generally refers to and includes homopolymer thermoplastics made by the polymerization of formaldehyde. As further background, Celcon® acetal (e.g., made by Celanese® Corporation) generally refers to and includes copolymer thermoplastics made by the copolymerization of trioxane (the cyclic trimer of formaldehyde) with a lesser amount of comonomer.

By way of example only, the needle-punched layer 182 may include needle-punched non-woven felt having the following fiber and physical properties. In this particular example, the fibers used for the needle-punched non-woven felt included 6-denier polyester fibers that are about 24.8 microns in diameter. Continuing with this example, the needle-punched non-woven felt had a weight within a range of about 8.8 ounces per square yard and about 10.3 ounces per square yard as measured per ASTM D-461-93 (Test Methods for Felt, issued December 2000), and a thickness within a range of about 0.059 inches and about 0.083 inches. The needle-punched non-woven felt in this example was also singed on one side by open-flame treatment of protruding surfaced fibers. This particular needle-punched non-woven felt had an air permeability within a range of about 130 cubic feet per square foot and about 210 cubic feet per square foot, at about a pressure differential of 0.50 inches of water (0.50″ H₂0 differential pressure) as measured per ASTM D 737-96 (Standard Test Method for Air Permeability of Textile Fabrics, approved Feb. 10, 1996). Per ASTM D 737-96, air permeability generally refers to the rate of air flow passing perpendicularly through a known area under a prescribed air pressure differential between the two surfaces of a material.

The fibers and physical properties of the needle-punched non-woven felt set forth in the immediately preceding paragraph are exemplary only, as other filter embodiments may include other needle-punched non-woven materials having different fiber types, sizes, configurations, air permeability, and/or other different physical properties depending, for example, on the particular application (e.g., fluid flow requirements, filtration requirements, desired life or longevity for the filtration media, etc.) in which the needle-punched non-woven filtration media will be used.

Any of the various embodiments of the present disclosure may include needle-punched non-woven filtration media configured with a decreasing gradient density (more open upstream and denser downstream) for achieving depth filtration. In such embodiments, the needle-punched non-woven filtration media may be provided with distinct regions or layers of decreasing interstitial or pore size and/or with a single region in which the interstitial or pore size decreases with depth. In such embodiments, this staged or depth filtration may improve the particulate retention capacity and lead to improved or better less flow restriction therethrough. The staged or depth media may also improve the service life of a filter inasmuch as each region or layer of the depth media or graduated filtration material is exposed to increasingly smaller particulate sizes. This occurs as each filtration region only traps particulates having a size relating to the filament and pore (interstitial) size in that larger particulates should have been trapped by previous larger filaments and pore (interstitial) sizes and with the smaller particulates traveling through to be trapped by subsequent finer filaments and smaller pore (interstitial) sizes.

In the illustrated embodiment of FIG. 3, for example, the layer 182 of needle-punched non-woven filtration media may be provided with a decreasing gradient density by calendaring a downstream surface of the layer 182 such that the downstream surface has a smaller interstitial or pore size than the upstream portion of layer 182. In other embodiments that include needle-punched non-woven filtration media with a decreasing gradient density, the layer 182 may include two or more different needle-punched non-woven felts that are laminated to one another to form the layer 182. In these particular embodiments, each felt may have smaller interstitial or pore sizes than the felt upstream thereof. In further alternative embodiments, the needle-punched non-woven filtration media may include both a calendared downstream surface and two or more felts laminated to one another. The graduated pore size provided by calendaring and/or laminating allows the needle-punched non-woven filtration media to first filter out larger particulate matter, and then filter out smaller particulate matter. Still further embodiments, however, may include needle-punched non-woven filtration media that is not configured for achieving the aforementioned depth filtration.

With continued reference to FIG. 3, each panel 170A and 170B also includes the layer 186. As shown in FIG. 3, the layer 186 is disposed downstream from the layers 178 and 182. In various embodiments, the layer 186 is configured for functioning as a migration barrier that inhibits fiber migration of the needle-punched non-woven filtration media.

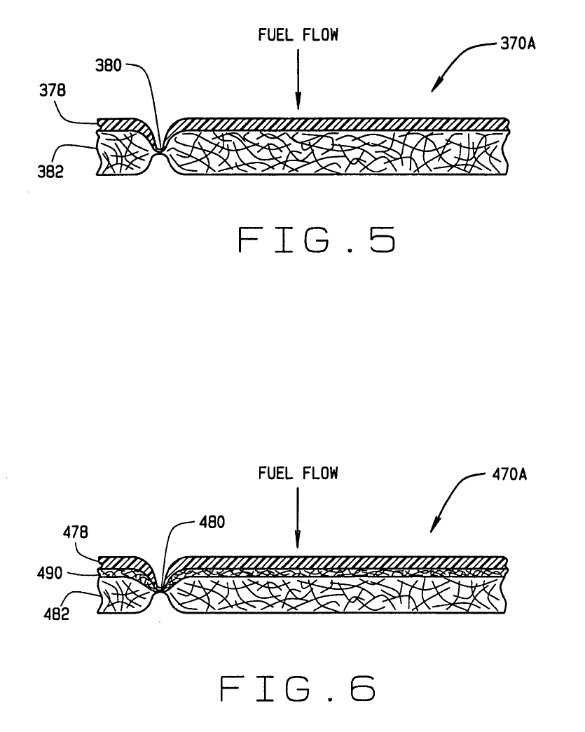

In this particular embodiment of FIG. 3, the layer 186 comprises a spun-bonded material, such as spun-bonded polyester, acetal, Teflon, combinations thereof, among other suitable fuel tolerant materials. In other embodiments, other materials besides spun-bonded materials may be used for the layer 186. In further embodiments, the layer 186 of spun-bonded material is eliminated as shown in the exemplary embodiments of FIGS. 5 and 6.

In various embodiments, the layer 186 of spun-bonded material has a relative coarseness or comparative pore size larger than the needle-punched non-woven filtration media 182. In which case, the layer 186 of spun-bonded material may contribute relatively little from the standpoint of filtration. In other embodiments, however, the layer 186 may instead be configured to have smaller interstitial or pore sizes than the layer 182 such that the layers 182 and 186 cooperatively achieve depth filtration.

Referring now to FIG. 4, there is shown a partial cross-sectional view of an alternative embodiment of an upper panel 270A of filtration media. The upper panel 270A (along with a lower panel of filtration media similar to panel 270A) may be used in a filter body for an in-tank fuel filter. Alternatively, the upper panel 270A may be used with other filters and/or the upper panel 270A may be used with a lower panel of filtration having a configuration different than panel 270A. For example, the upper panel 270A may be used with lower panel 170B (FIG. 3), or it may be used with a lower panel having a configuration similar to panel 370A (FIG. 5) or 470A (FIG. 6).

As shown in FIG. 4, the panel 270A includes a composite, sandwich or stack of layers 278, 282, 286, and 290. The panel 270A is bonded (at compressed regions 280) such that the panel 270A has spaced-apart regions of laminated or coupled layers 278, 282, 286, and 290.

In various embodiments, the layers 278, 282 and 286 may be identical to the respective layers 178, 182, and 186 described above. In such embodiments then, the outer layer 278 may comprise an outer protective covering, the layer 282 may comprise needle-punched non-woven filtration media, and the layer 286 may comprise spun-bonded materials.

In this particular embodiment, the panel 270A further includes the layer 290 disposed between layers 278 and 282. The layer 290 may be configured to have larger interstitial or pore sizes than the needle-punched non-woven layer 282 such that the layers 290 and 282 cooperatively achieve depth filtration. In addition, the layer 290 may be configured to have smaller interstitial or pore sizes than the outer layer 278 such that the layers 278 and 290 also cooperatively achieve at least some level of depth filtration.

The layers 286 and 290 may be configured to function as migration barriers for inhibiting respective downstream and upstream fiber migration from the needle-punched non-woven filtration media 282. In the illustrated embodiment of FIG. 4, the needle-punched non-woven filtration media 282 is encapsulated and contained within the layers 286 and 290 of spun-bonded material. Accordingly, the layers 286 and 280 may thereby inhibit migration of the needle-punched fibers into the fuel and fuel system of the vehicle.

In various embodiments, the layer 290 comprises a spun-bonded material, such as spun-bonded polyester, acetal, Teflon, combinations thereof, among other suitable fuel tolerant materials. In other embodiments, different materials besides spun-bonded materials may be used for the layer 290. Furthermore, the material(s) used for layer 290 may be the same as or different from the material(s) used for layer 286.

FIG. 5 illustrates another embodiment of an upper panel 370A of filtration media. This upper panel 370A (along with a lower panel of filtration media similar to panel 370A) may be used in a filter body for an in-tank fuel filter. Alternatively, the upper panel 370A may be used with other filters and/or the upper panel 370A may be used with a lower panel of filtration having a configuration different than panel 370A. For example, the upper panel 370A may be used with lower panel 170B (FIG. 3), or it may be used with a lower panel having a configuration similar to panel 370A (FIG. 5) or 470A (FIG. 6).

As shown in FIG. 5, the panel 370A includes a composite, sandwich or stack of layers 378 and 382. The panel 370A is bonded (at compressed regions 380) such that the panel 370A has spaced-apart regions of laminated or coupled layers 378 and 382.

In various embodiments, the layers 378 and 382 may be identical to the respective layers 178, 278, 182 and 282 described above. In such embodiments then, the outer layer 378 may comprise an outer protective covering, and the layer 382 may comprise needle-punched non-woven filtration media.

In this particular embodiment, however, the panel 370A does not include an inner layer for inhibiting migration of the needle-punched fibers. In some filtering applications, there may be little to no fiber migration such that a fiber migration barrier (e.g., 186, 286, etc.) is not necessarily needed for the panel 370A. For example, the panel 370A may be used to filter a fluid flow that is sufficiently low such that the fluid flow does not cause any significant or appreciable migration of the needle-punched fibers. Or, for example, the needle-punched non-woven filtration media 382 may be configured such that its fibers are sufficiently strong (e.g., bonded to one another, etc.) to withstand a fluid flow without significant or appreciable migration.

FIG. 6 illustrates a further embodiment of an upper panel 470A of filtration media. This upper panel 470A (along with a lower panel of filtration media similar to panel 470A) may be used in a filter body for an in-tank fuel filter. Alternatively, the upper panel 470A may be used with other filters and/or the upper panel 470A may be used with a lower panel of filtration having a configuration different than panel 470A. For example, the upper panel 470A may be used with lower panel 170B (FIG. 3), or it may be used with a lower panel having a configuration similar to panel 270A (FIG. 4) or 370A (FIG. 5).

As shown in FIG. 6, the panel 470A includes a composite, sandwich or stack of layers 478, 482, and 490. The panel 470A is bonded (at compressed regions 480) such that the panel 470A has spaced-apart regions of laminated or coupled layers 478, 482, and 490.

In various embodiments, the layers 478, 482, and 490 may be identical to the respective layers 178, 278, 378, 182, 282, 382, 290 described above. In such embodiments then, the outer layer 478 may comprise an outer protective covering, and the layer 482 may comprise needle-punched non-woven filtration media.

Continuing with this example, the layer 490 may comprise spun-bonded material (or other suitable material) configured for inhibiting migration of the needle-punched fibers. Additionally, or alternatively, the layer 490 may be configured to have larger interstitial or pore sizes than the needle-punched non-woven layer 482 such that the layers 490 and 482 cooperatively achieve depth filtration. In addition, the layer 490 may be configured to have smaller interstitial or pore sizes than the outer layer 478 such that the layers 478 and 490 also cooperatively achieve at least some level of depth filtration.

In the particular embodiment shown in FIG. 6, the panel 470A again does not include an inner layer for inhibiting migration of the needle-punched fibers. In some filtering applications, there may be little to no fiber migration such that a fiber migration barrier (e.g., 186, 286, etc.) is not necessarily needed for the panel 470A. For example, the panel 470A may be used to filter a fluid flow that is sufficiently low such that the fluid flow does not cause any significant or appreciable migration of the needle-punched fibers. Or, for example, the needle-punched non-woven filtration media 482 may be configured such that its fibers are sufficiently strong (e.g., bonded to one another, etc.) to withstand a fluid flow without significant or appreciable migration.

In any of the various embodiments of the present disclosure, the filter may be tailored or configured for fuel filtration focused in the seventy to one hundred micron range (or thereabout). For example, such filters may be tailored for efficiently filtering particulates ranging in size from about seventy microns to about one hundred microns. The inventors hereof have recognized that configuring a filter (e.g., 150, etc.) for fuel filtration focused within this seventy to one hundred micron range (or thereabout) allows such filters to have a relatively long service life when used with alternative fuels, such as flex fuels, methanol, ethanol, alcohol, among other alternative fuels derived from resources other than petroleum, etc. In comparison, existing filters relying on very fine melt-blown materials would likely filter out so many particulates from an alternative fuel (which are normally considerably dirty) that their service lives would be relatively short and would require frequent replacement to avoid clogging and insufficient fluid flow through the filter.

As further recognized by the inventors hereof, filters tailored or configured for fuel filtration focused in the seventy to one hundred micron range (or thereabout) are capable of separating potentially-problematic larger particulates from an alternative fuel (e.g., particulates large enough that could cause engine damage if allowed to pass into the engine) while allowing smaller particles to pass therethrough. Accordingly, various embodiments of the present disclosure were specially configured and tailored for fuel filtration focused in the seventy to one hundred microns (or thereabout), which, in turn, may provide filters with better particulate retention capacity and service lives than what is available with some current filtration media options.

In order to demonstrate various aspects and characteristics of embodiments of the present disclosure (e.g., flow resistance, filtration efficiency, particulate retention, chemical compatibility with flex fuels, etc.), exemplary test specimens and samples were created for performing multi-pass and flow-restriction testing, the results of which are set forth below for purposes of illustration only. For this multi-pass testing and flow-restriction testing, the test specimens or samples included needle-punched polyester material, outer or upstream polyester material, and inner or downstream spun-bonded polyester material.

More particularly, the outer polyester material of the test specimens included the following exemplary features (or thereabout): 800 micron pore size, 55% open area percentage, 520 micron fabric thickness, 4.87 ounces per square yard, 280 micron fiber diameter, plain wave type, and 22.9 mesh count.

For the needle-punched polyester material of the test specimens, 6-denier polyester fibers were used that were about 24.8 microns in diameter. The needle-punched non-woven polyester had a weight within a range of about 8.8 ounces per square yard and about 10.3 ounces per square yard as measured per ASTM D-461-93 (Test Methods for Felt, issued December 2000), and a thickness within a range of about 0.059 inches and about 0.083 inches. The needle-punched non-woven polyester for the test specimens were also singed on one side by open-flame treatment of protruding surfaced fibers, and had an air permeability within a range of about 130 cubic feet per minute per square foot and about 210 cubic feet per minute per square foot, at about a pressure differential of 0.50 inches of water (0.50″ H₂0 differential pressure) as measured per ASTM D 737-96 (Standard Test Method for Air Permeability of Textile Fabrics, approved Feb. 10, 1996).

Continuing with the description of the test specimens, the downstream or inner spun-bonded polyester material had a weight of about 34 grams per square meter (or about 1.0 ounce per square yard) and a thickness of about 12 mils. The spun-bonded polyester for the test specimens also had an air permeability of about 900 cubic feet per minute per square foot, a Mullen Burst of about 33 pounds per square inch, and grab tensile of about 18/12 machine direction/cross machine direction, pounds.

In one particular series of tests, filter performance was evaluated using multi-pass testing per ISO 16889 (“Hydraulic fluid power filters—Multi-pass method for evaluating filtration performance of a filter element”, adopted December 1999). A test stand (TS010 Multi-pass) and a housing (flat sheet, 156 millimeters (6.13 inches) inner diameter disk) were used for holding the test specimens during the multi-pass testing. Particle counter settings for the testing were 30, 40, 50, 60, 70, 80, 90, 100 microns. The test fluid used was Mobil Aero HFA (MIL-H5606) at a flow rate of 4.0 gallons per minutes (GPM), a temperature of 100 degrees Fahrenheit, an upstream concentration of 13.0 milligrams per liter (mg/L), and a termination point of 10.0 pounds per square inch differential (psid). The contaminant for the testing was ISO Coarse Test Dust.

Exemplary multi-pass test results are set forth below in Tables 1 and 2 for purposes of illustration only.

TABLE 1
Averaged Multi-Pass Test Results

| | |
|---|---|
| Retained Capacity (grams) | 5.96 |
| Initial Restriction (pounds per square inch) | 0.18 |

TABLE 2
Multi-Pass Test Results for Filtration Efficiency

| Micron Size (μm) | Average Efficiency (%) |
|---|---|
| 30.0 | 42.36 |
| 40.0 | 78.72 |
| 50.0 | 90.82 |
| 60.0 | 96.86 |
| 70.0 | 98.34 |
| 80.0 | 99.23 |
| 90.0 | 99.92 |
| 100.0 | 100.00 |

As can be seen in Table 2, the test specimens were highly efficient (e.g., above ninety percent efficiency, etc.) at filtering particulates having a size greater than fifty microns. The inventors hereof have recognized that filters configured or tailored with focused fuel filtration consistent with the experimental data shown in Table 2 should have relatively long service lives when used with alternative fuels by allowing the smaller particulates to pass therethrough, while also effectively filtering out the larger particulates from the alternative fuel. And, as shown in Table 1, the test specimens with their depth filtration also possessed better particulate retention capacity than existing conventional filter screens having only surface filtration.

In another particular series of tests, filter performance was evaluated using flow restriction testing per SAE J905 modified (“Fuel Filter Test Methods”, January 1999). A test stand (TS3 Fuel Flow) and a fixture (47 millimeter inner diameter housing with internal gaskets and perforated stainless steel media support) were used for holding the test specimens during the flow restriction testing. The gauges used were Dwyer Series 476 Mark III digital manometer (S/N N00253). The test fluid used was Mineral Spirits at room temperature. Flow rates for the testing were from 20 to 180 liters per hour (LPH) in increments of 10.

Exemplary flow restriction test results are set forth below in Table 3 for purposes of illustration only.

TABLE 3
Flow Drop Results
Experimental Data (Area = 1734 square millimeters)

| Flow Rate (liters per hour) | Pressure drop(kilopascals) |
|---|---|
| 20 | 0.04 |
| 30 | 0.08 |
| 40 | 0.16 |
| 50 | 0.19 |
| 60 | 0.27 |
| 70 | 0.31 |
| 80 | 0.36 |
| 90 | 0.43 |
| 100 | 0.50 |
| 120 | 0.70 |
| 140 | 0.87 |
| 160 | 0.97 |
| 180 | 1.16 |

In various embodiments of the present disclosure, the filtration media and/or in-tank fuel filter may also include other non-woven materials (in addition to, or as an alternative to) that offer similar performance as does the needle-punched non-woven materials described above. A wide range of non-woven materials may be used instead of or along with (e.g., adjacent and/or bonded thereto, etc.) needle-punched non-woven materials. Examples of such non-woven materials include thermal bonded non-woven materials, spunlaced (hydroentangled) non-woven materials, stitchbonded non-woven materials, combinations thereof, among other suitable non-woven materials bonded with other means besides needle-punching. By way of background only, an exemplary thermal-bonded non-woven method may include fusing fiber surfaces to each other either by softening the fiber surface (e.g., if they melt at low temperatures, etc.) and/or by melting fusible additives in the form of powders or fibers. An exemplary spun-laced (also generally referred to as hydroentangled) process may use fine, high velocity jets of water to impact a fibrous web and cause the fibers to curl and entangle about each other. An exemplary stitchbonding process may use a continuous filament to sew a web of unbonded fibers into a fabric with a stitch pattern.

Certain terminology is used herein for purposes of reference only, and thus is not intended to be limiting. For example, terms such as “upper”, “lower”, “above”, and “below” refer to directions in the drawings to which reference is made. Terms such as “front”, “back”, “rear”, “bottom” and “side”, describe the orientation of portions of the component within a consistent but arbitrary frame of reference which is made clear by reference to the text and the associated drawings describing the component under discussion. Such terminology may include the words specifically mentioned above, derivatives thereof, and words of similar import. Similarly, the terms “first”, “second” and other such numerical terms referring to structures do not imply a sequence or order unless clearly indicated by the context.

When introducing elements or features of the present disclosure and the exemplary embodiments, the articles “a”, “an”, “the” and “said” are intended to mean that there are one or more of such elements or features. The terms “comprising”, “including” and “having” are intended to be inclusive and mean that there may be additional elements or features other than those specifically noted. It is further to be understood that the method steps, processes, and operations described herein are not to be construed as necessarily requiring their performance in the particular order discussed or illustrated, unless specifically identified as an order of performance. It is also to be understood that additional or alternative steps may be employed.

The description of the disclosure is merely exemplary in nature and, thus, variations that do not depart from the gist of the disclosure are intended to be within the scope of the disclosure. Such variations are not to be regarded as a departure from the spirit and scope of the disclosure.

What is claimed is:

1. An in-tank fuel filter suitable for filtering alternative fuels, the filter comprising a filter body having an interior, first and second panels of filtration media, the first and second panels of filtration media including needle-punched non-woven filtration media comprising at least one or more of polyester and acetal, and an opening in the filter body for providing fluid communication with the interior of the filter body.

2. The filter of claim 1, wherein the needle-punched non-woven filtration media comprises acetal fibers.

3. The filter of claim 1, wherein the needle-punched non-woven filtration media comprises polyester fibers.

4. The filter of claim 1, wherein the filter is tailored for filtering particulates having a size less than about fifty microns at an efficiency of about ninety percent or less, and for filtering particulates having a size greater than about fifty microns at an efficiency of about ninety percent or greater.

5. The filter of claim 1, wherein the filter is tailored for fuel filtration focused within the range of about seventy microns to about one hundred microns.

6. The filter of claim 1, wherein at least portions of the first and second panels of filtration media are configured with a decreasing gradient density in the direction of fluid flow for achieving graduated depth filtration.

7. The filter of claim 1, wherein the needle-punch non-woven filtration media includes at least one downstream surface portion calendared for achieving graduated depth filtration within the needle-punched non-woven filtration media in the direction of fluid flow through the needle-punched non-woven filtration media.

8. The filter of claim 1, wherein the needle-punched non-woven filtration media includes at least two layers of needle-punched non-woven material having different pore sizes, the layer having the smaller pore size being disposed downstream of the other layer for achieving graduated depth filtration within the needle-punched non-woven filtration media in the direction of fluid flow through the needle-punched non-woven filtration media.

9. The filter of claim 1, wherein the first and second panels of filtration media include at least one protective layer external to the needle-punched non-woven filtration media.

10. The filter of claim 1, wherein the first and second panels further include spun-bonded material.

11. The filter of claim 10, wherein at least a portion of the spun-bonded material is disposed upstream of the needle-punched non-woven filtration media for providing graduated depth filtration in the direction of fluid flow through the first and second panels.

12. The filter of claim 10, wherein at least a portion of the spun-bonded material is disposed downstream of the needle-punched non-woven filtration media for inhibiting fiber migration of the needle-punched filtration media.

13. The filter of claim 10, wherein the needle-punched non-woven filtration media is contained within the spun-bonded material.

14. Filtration media for in-tank fuel filter assemblies suitable for filtration of alternative fuels, the filtration media comprising at least one needle-punched non-woven material, the needle-punched non-woven material comprising at least one or more of polyester and acetal.

15. The filtration media of claim 14, wherein the filtration media is tailored for filtering particulates having a size less than about fifty microns at an efficiency of about ninety percent or less, and for filtering particulates having a size greater than about fifty microns at an efficiency of about ninety percent or greater.

16. The filtration media of claim 14, wherein the filtration media is tailored for fuel filtration focused within the range of about seventy microns to about one hundred microns.

17. The filtration media of claim 14, wherein the needle-punched non-woven material comprises acetal fibers.

18. The filtration media of claim 14, wherein the needle-punched non-woven material comprises polyester fibers.

19. The filtration media of claim 14, wherein at least portions of the needle-punched non-woven material are configured with a decreasing gradient density in the direction of fluid flow for achieving graduated depth filtration.

20. The filtration media of claim 14, wherein the needle-punch non-woven material includes at least one downstream surface portion calendared for achieving graduated depth filtration within the needle-punched non-woven material in the direction of fluid flow through the needle-punched non-woven material.

21. The filtration media of claim 14, wherein the needle-punched non-woven material includes at least two layers of needle-punched non-woven material having different pore sizes, the layer having the smaller pore size being disposed downstream of the other layer for achieving graduated depth filtration within the needle-punched non-woven material in the direction of fluid flow through the needle-punched non-woven material.

22. The filtration media of claim 14, further comprising at least one material upstream of and having a larger pore size than the needle-punched non-woven material for providing graduated depth filtration in the direction of fluid flow through the filtration media.

23. The filtration media of claim 14, further comprising at least one material disposed generally downstream from the needle-punched non-woven material for inhibiting fiber migration of the needle-punched non-woven material.

24. The filtration media of claim 14, further comprising first and second layers of spun-bonded material, and wherein the needle-punched non-woven material is generally disposed between the first and second layers of spun-bonded material, whereby the needle-punched non-woven material cooperates with the first layer of spun-bonded material for achieving graduated depth filtration, and whereby the second layer of spun-bonded material inhibits fiber migration of the needle-punched non-woven material.

25. A method of filtering particulates from an alternative fuel with a filter having needle-punched non-woven filtration media that includes at least one or more of polyester and acetal, and tailored for fuel filtration focused within the range of about seventy microns to about one hundred microns, the method comprising positioning the filter relative to a flow of alternative fuel such that the filter filters from the alternative fuel at least about ninety percent or more of the particulates having a size greater than about fifty microns and filters from the alternative fuel about ninety percent or less of the particulates having a size less than about fifty microns.

26. The method of claim 25, wherein positioning the filter relative to a flow of alternative fuel includes positioning the filter relative to a flow of at least one or more methanol, ethanol, alcohol, flex fuels, or a combination thereof.
